(19) United States
(12) Patent Application Publication
(10) Pub. No.: US 2009/0262728 A1
(43) Pub. Date: Oct. 22, 2009

(54) METHOD FOR ROUTING OF CONNECTIONS IN A PACKET-SWITCHED COMMUNICATION NETWORK

(75) Inventor: Rainer Stademann, Berg (DE)

Correspondence Address: LERNER GREENBERG STEMER LLP, P O BOX 2480, HOLLYWOOD, FL, 33022-2480, US

(73) Assignee: Nokia Siemens Networks GmbH & Co. KG, Munich (DE)

(21) Appl. No.: 12/160,407

(22) PCT Filed: Sep. 25, 2006
(86) PCT No.: PCT/EP06/66690

§ 371 Date: Apr. 22, 2009

(30) Foreign Application Priority Data
Jan. 10, 2006 (DE) 10 2006 001 273.9

(51) Int. Cl. H04L 12/56; H04L 12/66

(52) U.S. Cl. 370/352; 370/395.53

(57) ABSTRACT

The invention relates to a method for routing connections in a packet-switched communication network. Said method is characterized in that the communication network comprises a plurality of virtual local area networks, to each of which at least one network transition between the communication network and another network is allocated, while said connection is assigned to a virtual local area network based on an operator selection code when a connection is established.

The invention relates to a method for routing of connections in a packet-switched communication network.

In the case of line-switched telecommunication networks based on the time-division multiplexing principle, it is possible according to the prior art for the subscribers to select a wide area network operator for a desired connection by dialing an operator dialing code. The respective call is in this case passed on from the local network operator to a network gateway for the respectively desired wide area network operator, on the basis of the chosen operator dialing code. This wide area network operator then passes on the call via his own network to the destination.

While this function is prior art for line-switched networks using the time-division multiplexing principle, the following problem occurs in telephone networks based on the Ethernet and IP technology.

The operator of a local area network shown route the Voice-over-IP packets for the associated connection between two subscribers via a predetermined IP network gateway (POI=point of interconnect) for the selected wide area network operator as a function of the chosen operator dialing code for the call. The IP destination address of the called subscriber is, however, generally independent of the chosen wide area network operator, so that this destination address for the IP packets cannot be used as a criterion for routing in the local area network.

Without special measures, the Voice-over-IP packets are therefore routed via a possible connection between the two subscribers, independently of the chosen carrier code. The choice of the IP wide area network is in this case governed solely by inter-domain routing protocols for the IP networks, such as the BGP (Border Gateway Protocol, RFC 1771), and not by the operator dialing code.

The invention is also based on the object of specifying a method by means of which Voice-over-IP packets can be routed via predetermined network gateways based on an operator dialing code.

According to the invention, this object is achieved by a method for routing of connections in a packet-switched communication network, in which the communication network has a plurality of virtual local area networks, each of which has an associated network gateway between the communication network and a further network, and in that, when setting up a connection on the basis of an operator dialing code, this connection is associated with one virtual local area network.

The advantages of the solution according to the invention are, in particular, the low implementation costs since no special network elements such as IP-IP gateways are required, and additionally the low administrative effort, since only a small amount of data need be handled. A further benefit of the method according to the invention is also the low failure rate, since no connection-related states need be held in the IP network, but only in the Voice-over-IP gateways.

It is advantageous for the communication network to be based on the Ethernet Standard in accordance with IEEE 802.3, and for the virtual local area networks to be designed in accordance with IEEE 802.1q.

It is also particularly advantageous to use the method for routing of Voice-over-IP connections.

The invention will be explained in more detail with reference to figures.

In the figures, by way of example:

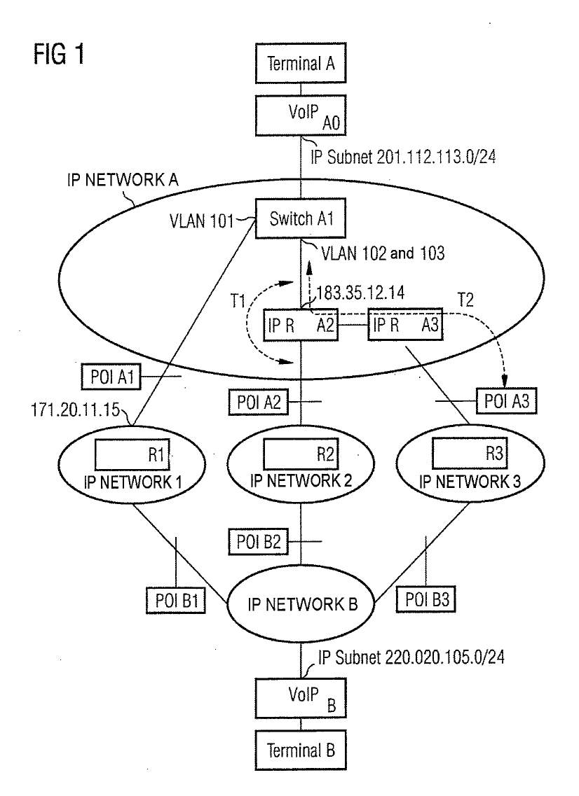

FIG. 1 shows, schematically, a communication network which is designed to carry out the method according to the invention,

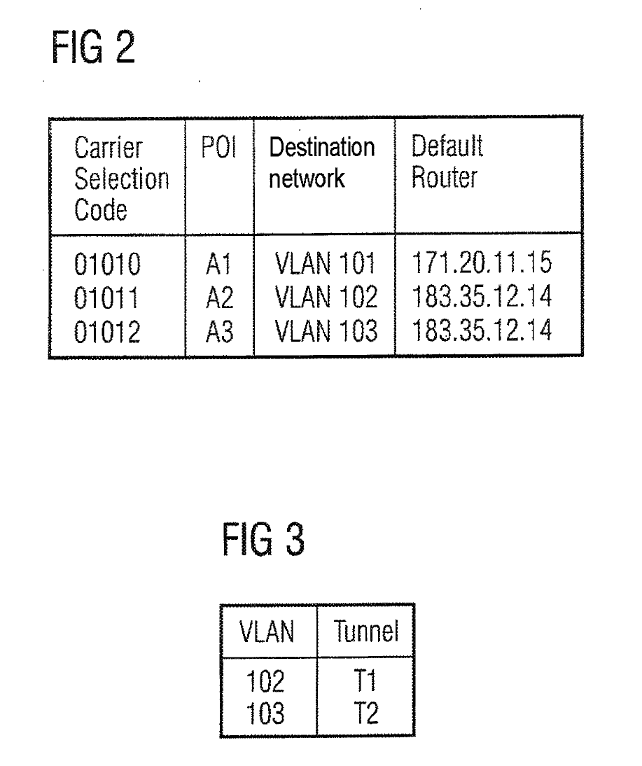

FIG. 2 shows a table by means of which the operator dialing codes can be associated with a virtual local area network, and

FIG. 3 shows the association between virtual local area networks and tunnels.

The communication network shown in FIG. 1 has the subscriber terminals A and B between which a connection is intended to be set up. Two subscribers are connected via respective Voice-over-IP gateways VOIP A, VOIP B to a respective local packet-switched communication network, network A, network B. The two local communication networks network A, network B are also connected via network gateways POI A1, POI A2, POI A3, POI B1, POI B2, POI B3 to wide area traffic networks IP network 1, IP network 2, IP network 3. A connection between the two subscribers therefore runs through the two local area networks network A, network B, and through at least one of the wide area traffic networks IP network 1, IP network 2, IP network 3. the local communication networks network A, network B are based on the Ethernet Standard in accordance with IEEE 802.3, and have Ethernet switches switch A1 and routers IP R A2, IP R A3.

Only the IP destination address is evaluated in routing methods according to the prior art. In the exemplary embodiment, these originate from the IP subnetwork 201.112.113.0/24 for the Voice-over-IP gateway VOIP A of the subscriber A, and the IP subnetwork 220.020.105.0/24 for the Voice-over-IP gateway VOIP b of the subscriber B.

According to the prior art, the data packets are routed via one of the wide area traffic networks IP network 1, IP network 2, IP network 3. The choice of the IP transit network is in this case governed solely by inter-domain routing protocols for the IP networks, such as the BGP (Border Gateway Protocol, RFC 1771), and not by an operator dialing code.

According to the invention, the local packet-switched communication networks network A, network B are now subdivided into a plurality on virtual local area networks VLAN 101; VLAN 102 and VLAN 103, with at least one respectively associated network gateway POI A1, POI A2, POI A3.

These virtual local area networks VLAN 101, VLAN 102 and VLAN 103 are associated with operator dialing codes by means of an association table as shown in FIG. 2. The table is held in the Voice-over-IP gateway VOIP A of the subscriber A and is used when this subscriber is setting up a connection to route the connection on the basis of the stated operator dialing code via the associated virtual local area networks VLAN 101; VLAN 102 and VLAN 103, the respectively associated network gateway POI A1, POI A2, POI A3 and the corresponding wide area network IP network 1, IP network 2, IP network 3.

If the local communication networks network A, network B are based on the Ethernet Standard in accordance with IEEE 802.3, and the virtual local area networks are designed in accordance with IEEE 802.1q, the procedure for the method according to the invention is as follows:

When setting up a Voice-over-IP connection from a calling subscriber A to a called subscriber, in which the aim is to route a connection via the first wide area network IP network 1 at the request of the calling subscriber A, the subscriber A will enter the operator dialing code 01010.

A table which can be administered as shown in FIG. 2 is used in the Voice-over-IP gateway VOIP A for the subscriber A to allocate the first virtual local area networks VLAN 101 to the operator dialing code 01010 and the data packets for this connection are identified by the VLAN tag 101 in accordance with IEEE Standard 802.1q, or proprietary formats derived from it such as “stacked VLAN” or “VMAN”. In addition, the IP addresses may be defined by default IP routers which can be accessed via the respective virtual local area network VLAN 101, VLAN 102, VLAN 103.

The Voice-over-IP gateway VOIP A uses a numerical analysis to determine the associated network gateway POI A1, and marks outgoing Ethernet frames for this connection with the associated VLAN tag 101. Conversely, incoming Ethernet frames are considered for this connection only if they have the appropriate VLAN tags 101. This means that incoming IP packets in the RTP streams (Real Time Transport Protocol, RFC 1889) are evaluated for a connection only when they arrive in Ethernet frames with the appropriate VLAN tag 101.

In the exemplary embodiment, a first router R1 for the first wide area traffic network IP network 1 is connected directly to a separate port of the Ethernet switch, switch A1. This port has been administratively associated with the first virtual local area network VLAN 101. In consequence, only frames which have this VLAN tag 101 are passed on from the Ethernet switch Switch A1 to the first wide area network IP network 1. Conversely, the switch A1 marks all the Ethernet frames which arrive from the first router R1 with the VLAN tag 101.

The other wide area traffic networks IP network 2, IP network 3 are not connected directly to the Ethernet switch A1, but to the second or third router IPR A2, IPR A3 for the local packet-switched communication network IP network A. The second router IPR A2 is connected to one port of the Ethernet switch SWITCH A1. This port has been administratively associated with the second and the third virtual local area networks VLAN 102, VLAN 103. In consequence, only Ethernet frames which have one of the two VLAN labels 102, 103 are passed on to the second router IPR A2.

This is connected to the further wide area traffic networks IP network 2, IP network 3, in each case via a so-called tunnel T1, T2. By way of example, this can be done using MPLS (Multi-Protocol-Label-Switching), GRE (Generic Routing Encapsulation, RFC1701) or some other suitable tunneling technique.

A table as shown in FIG. 3 is administered in the second router IPR A2 for this purpose, providing an association between the VLAN tags 102, 103 and the tunnels T1, T2. IP packets which reach the router A2 in Ethernet frames of the VLAN 102 are fed on the basis of this association into the tunnel T1, and are tunneled to the second wide area traffic network IP network 2.

Conversely, IP packets in the second wide area traffic network IP network 2 which reach the second router A2 via the first tunnel T1 are packaged by this into Ethernet frames for the second virtual local area networks VLAN 102, and are sent via the Ethernet switch Switch A1 to the Voice-over-IP gateway VOIP A.

IP packets are routed analogously between the third virtual local area networks VLAN 103 and the third wide area traffic network IP network 3 via the second tunnel T2.

The method for routing of the IP packets for a connection in the opposite direction is carried out in a corresponding manner.

1. A method for routing connections in a packet-switched communication network, wherein the communication network has a plurality of virtual local area networks, each of which has an associated network gateway between the communication network and an additional network, comprising associating the connection with one virtual local area network when setting up a connection based on an operator dialing code.

2. The method as claimed in claim 1, wherein the communication network is based on an Ethernet Standard in accordance with IEEE 802.3, and in the virtual local area networks are designed in accordance with IEEE 802.1q.

3. The method as claimed in claim, wherein Voice-over-IP connections are provided as connections.
